(19) United States
(12) Patent Application Publication
(10) Pub. No.: US 2013/0207499 A1
(43) Pub. Date: Aug. 15, 2013

(54) ROTOR ASSEMBLY FOR MOTOR AND SPINDLE MOTOR INCLUDING THE SAME

(71) Applicant: SAMSUNG ELECTRO-MECHANICS CO., LTD., (US)

(72) Inventors: Dong Woo RHEE, Suwon-si (KR); Ho Jun YOO, Suwon-si (KR); Jae Yoon KIM, Suwon-si (KR); Pyo KIM, Suwon-si (KR)

(73) Assignee: SAMSUNG ELECTRO-MECHANICS CO., LTD., Suwon-si (KR)

(21) Appl. No.: 13/706,193

(22) Filed: Dec. 5, 2012

(30) Foreign Application Priority Data
Dec. 5, 2011 (KR) 10-2011-0129026

(51) Int. Cl. H02K 1/27

(52) U.S. Cl. CPC H02K 1/2786
USPC 310/156.12

(57) ABSTRACT

There are provided a rotor assembly for a motor and a spindle motor including the same. The rotor assembly includes: a rotor case including a rotor hub fixed to a shaft, a rotor extension part extended from the rotor hub in an outer radial direction, and a magnet coupling part extended from the rotor extension part in a downward axial direction; and a magnet provided on an inner surface of the magnet coupling part, wherein a thickness of the magnet in a radial direction may correspond to 8.5 to 20% of a distance from a center of rotation of the rotor case to an edge of the rotor case in the outer radial direction.

### CROSS-REFERENCE TO RELATED APPLICATIONS

This application claims the priority of Korean Patent Application No. 10-2011-0129026 filed on Dec. 5, 2011, in the Korean Intellectual Property Office, the disclosure of which is incorporated herein by reference.

### BACKGROUND OF THE INVENTION

1. Field of the Invention

The present invention relates to a rotor assembly for a motor and a spindle motor including the same.

2. Description of the Related Art

In general, a spindle motor installed in a disk drive serves to rotate a disk such that an optical pickup mechanism may read data recorded on the disk.

Meanwhile, the disk drive is used in a portable multimedia device such as a laptop computer that maybe carried with a user and used anytime and anywhere. Therefore, in accordance with the trend for the miniaturization of portable multimedia devices, device manufacturers have attempted to thin disk drives.

In addition, a majority of current spindle motors installed in the disk drives have a coil wound around a stator core and use electromagnetic force generated by current flowing in the coil wound around the stator core as a power source for the generation of rotational torque thereof.

Further, in order to thin the above-mentioned disk drive, the manufacturer has attempted to thin the spindle motor. Therefore, a technology of thinning components, for example, a stator and a rotor, configuring the spindle motor so as to realize thinness in the spindle motor has been urgently demanded.

Meanwhile, as a material of a magnet included in the rotor in the spindle motor and interacting with the stator core to provide rotational driving force to the rotor, neodymium (Nd) is mainly used. However, recently, due to an increase in demand for neodymium magnets and an increase in raw material costs due to the scarcity of rare earth elements, a cost of the magnet has increased, such that a cost of the motor has increased. Therefore a material capable of being substituted for neodymium, a material used for the the magnet according to the related art, has been demanded.

### SUMMARY OF THE INVENTION

An aspect of the present invention provides a spindle motor in which a deterioration in performance thereof is prevented, despite using a magnet formed of ferrite or samarium cobalt (SmCo) having relatively weak magnetic force as compared to neodymium.

According to an aspect of the present invention, there is provided a rotor assembly for a motor, including: a rotor case including a rotor hub fixed to a shaft, a rotor extension part extended from the rotor hub in an outer radial direction, and a magnet coupling part extended from the rotor extension part in a downward axial direction; and a magnet provided on an inner surface of the magnet coupling part, wherein a thickness of the magnet in a radial direction may correspond to 8.5 to 20% of a distance from a center of rotation of the rotor case to an edge of the rotor case in the outer radial direction.

The magnet may be formed of at least one of ferrite and samarium cobalt (SmCo).

The magnet may be provided in an annular ring shape on the inner surface of the magnetic coupling part.

According to another aspect of the present invention, there is provided a spindle motor including: a sleeve supporting a shaft such that an upper end of the shaft protrudes in an upward axial direction; a rotor assembly for a motor, including a rotor case including a rotor hub fixed to a shaft, a rotor extension part extended from the rotor hub in an outer radial direction, and a magnet coupling part extended from the rotor extension part in a downward axial direction, and a magnet provided on an inner surface of the magnet coupling part, a thickness of the magnet in a radial direction corresponding to 8.5 to 20% of a distance from a center of rotation of the rotor case to an edge of the rotor case in the outer radial direction; and a stator directly or indirectly coupled to an outer peripheral surface of the sleeve and having a coil wound therearound so as to generate rotational driving force.

The magnet may be formed of at least any one of ferrite and samarium cobalt (SmCo).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention; and

FIG. 2 is a schematic cross-sectional view showing a rotor assembly according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Hereinafter, a spindle motor including a rotor assembly according to an embodiment of the present invention will be described in detail.

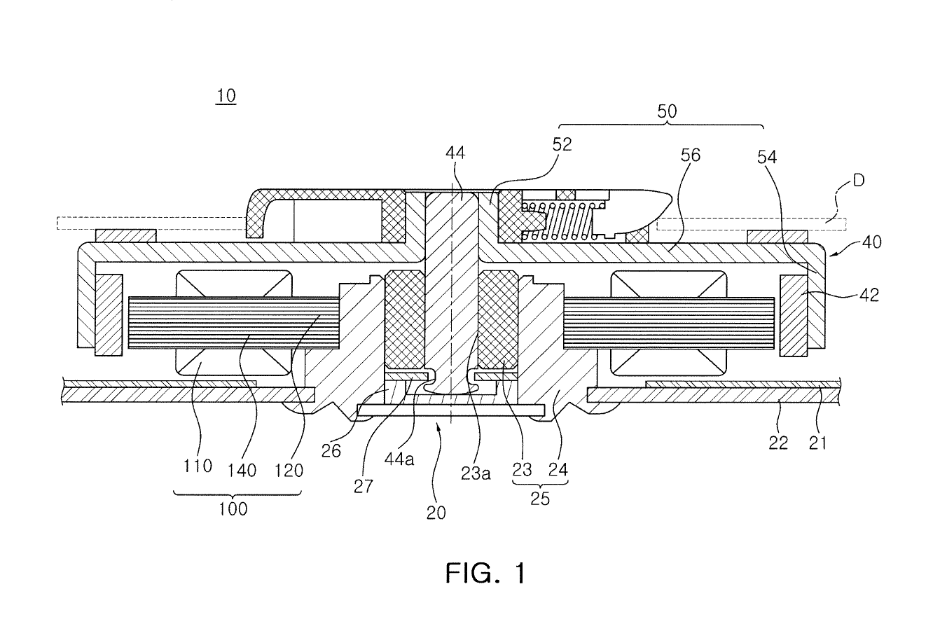

FIG. 1 is a schematic cross-sectional view showing a spindle motor according to an embodiment of the present invention.

Referring to FIG. 1, a spindle motor 10 according to the embodiment of the present invention may include a stator 20 and a rotor 40.

First, terms with respect to directions will be defined. A radial direction refers to a direction between the center of rotation of the spindle motor and an outer edge thereof, an outer radial direction refers to a direction from the center of rotation of the spindle motor toward the outer edge thereof, and an inner radial direction refers to a direction from the outer edge of the spindle motor toward the center of rotation thereof. That is, when viewed in FIG. 1, a direction from a rotor hub 52 toward a magnet coupling part 54 based on a rotor case 50 refers to the outer radial direction. This direction refers to a direction perpendicular to a rotational axis.

Further, when viewed in FIG. 1, an axial direction refers to a direction of the shaft, an upward axial direction refers to a direction toward an upper portion of the shaft (upwardly in the axial direction), and a downward axial direction refers to a direction toward a lower portion of the shaft (downwardly in the axial direction).

The stator 20, all fixed components except for rotating components, may include a base plate 22 having a printed circuit board 21 installed thereon, a fixed member 25 including a sleeve 23, a sleeve holder 24, and a cover member 26, and a stator core 100 fixedly installed on the fixed member 25. Meanwhile, the fixed member 25 may further include the base plate 22 configuring a base of the spindle motor, the base plate 22 may include the printed circuit board 21 provided thereon.

The rotor 40 may include the rotor case 50 having a cup shape and including a magnet 42 disposed on an outer circumferential surface thereof, the magnet 42 having an annular ring shape and corresponding to the stator core 100. The magnet 42 may be a permanent magnet generating magnetic force having a predetermined strength by alternately magnetizing an N pole and an S pole in a circumferential direction.

The sleeve 23 may be a member supporting a shaft 44 in such a manner that an upper end of the shaft 44 protrudes in the upward axial direction. The sleeve 23 may be formed by forging Cu or Al or sintering a Cu—Fe-based alloy powder or a SUS-based powder.

Here, the shaft 44 may be inserted into a shaft hole 23a of the sleeve 23 so as to form a micro clearance therebetween. The micro clearance may be filled with a lubricating fluid, and the rotation of the rotor 40 may be more smoothly supported by radial dynamic pressure grooves formed in at least one of an outer diameter portion of the shaft 44 and an inner diameter portion of the sleeve 23.

The radial dynamic pressure grooves may be formed in an inner surface of the sleeve 23, an inner portion of the shaft hole 23a of the sleeve 23, and may generate pressure such that the sleeve 23 and the shaft 44 are spaced apart from each other by a predetermined distance at the time of rotation of the shaft 44.

However, the radial dynamic pressure groove is not limited to being formed in the inner surface of the sleeve 23 as described above, but may also be formed in the outer diameter portion of the shaft 44. In addition, the number of radial dynamic pressure grooves is not limited.

The sleeve 23 may include a bypass channel (not shown) formed therein such that upper and lower portions thereof may be in communication with each other to disperse pressure in the lubricating fluid in a hydrodynamic bearing assembly, thereby allowing for balance in pressure and allowing air bubbles, or the like, present in the hydrodynamic bearing assembly, to be discharged by circulation.

Meanwhile, an outer circumference of the sleeve 23 may be provided with the sleeve holder 24 receiving the sleeve 23 therein so as to be fixed.

The cover member 26 may be coupled to a lower portion of the sleeve holder 24 in the axial direction, while having a lower end of the shaft 44 seated thereon, and may receive a lubricating fluid thereon. When the shaft 44 rotates, the shaft 44 may be floated from the cover member 26.

The cover member 150 may receive the lubricating fluid thereon to serve as a bearing supporting a lower surface of the shaft 44.

Further, a lower portion of the sleeve 23 may be provided with a stopper 27 coupled to the sleeve holder 24 or the cover member 26. The stopper 27 may have an annular ring shape and be caught by a depression part 44a formed in an inner diameter portion of the shaft 44 at a lower end of the shaft 44. The stopper 27 may limit excessive floating of the shaft 44 to limit floating the rotor 40.

The rotor case 50 may include the rotor hub 52 press-fitted onto and coupled to the shaft 44, a rotor extension part 56 extended from the rotor hub 52 in the outer radial direction, and the magnet coupling part 54 having the magnet 42 disposed on an inner surface thereof.

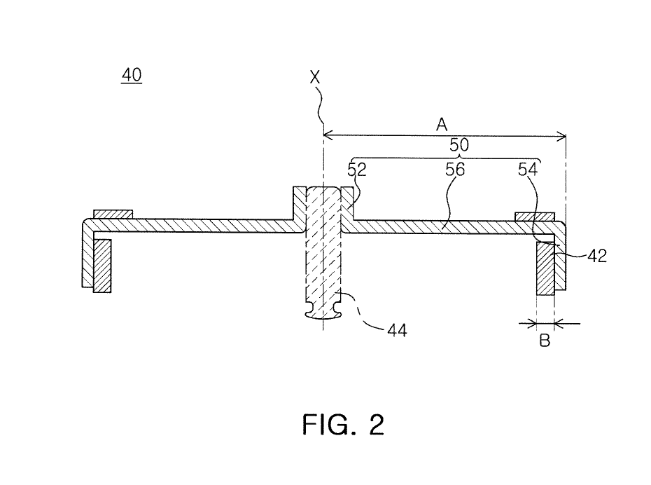

More specifically, the rotor case 50 may include the rotor hub 52 fixed to the shaft 44, the rotor extension part 56 extended from the rotor hub 52 in the outer radial direction, and the magnet coupling part 54 extended from the rotor extension part 56 in the downward axial direction. A structure thereof will be described below in more detail with reference to FIG. 2.

Meanwhile, the rotor may rotate due to electromagnetic interaction between the magnet 42 and a coil 110 wound around the stator core 100. In other words, when the rotor case 50 of the rotor 40 rotates, the shaft 40 may rotate together with the rotor case 50.

Here, the magnet 42 may be formed of at least one of ferrite and samarium cobalt (SmCo). A detailed description thereof will be provided below with reference to FIG. 2.

The stator core 100 may include a coreback 120 and a teeth part 140 as described in detail in the description of the stator core 100 according to the embodiment of the present invention.

The coreback 120 may include an opening formed therein such that the coreback 120 may be press-fitted into and fixed to the fixed member 25. The opening part into which the fixed member 25 is press-fitted may be disposed, for example, in the center of the coreback 120, which may have a ring shape. Meanwhile, although the case in which the coreback 120 is fixed to the sleeve holder 24 of the fixed member 25 has been shown in FIG. 1, the coreback 120 may be fixed to an outer peripheral surface of the sleeve 23.

The teeth part 140 may be provided in plural and a plurality of teeth parts 140 may protrude from the coreback 120 in the outer radial direction.

FIG. 2 is a schematic cross-sectional view showing a rotor assembly according to the embodiment of the present invention.

Referring to FIG. 2, in the rotor 40 (hereinafter, also referred to as a ‘rotor assembly) , a thickness B of the magnet 42 in the radial direction may correspond to 8.5 to 20% of a distance A from a center X of rotation (the rotational axis) of the rotor case 50 to an edge of the rotor case 50 in the outer radial direction.

In the case in which a neodymium magnet is used in the spindle motor, since magnetic force of the neodymium magnet is strong, a thickness of the magnet in the radial direction may generally correspond 7.5 to 8% of a distance from the center of rotation of the rotor case to the edge of the rotor case in the outer radial direction.

According to the embodiment of the present invention, at least one of ferrite and samarium cobalt (SmCo) having magnetic force slightly weaker than that of neodymium may be used. That is, ferrite, samarium cobalt, or a mixture thereof may be used as a material of the magnet.

Meanwhile, in the case of using a material such as ferrite, samarium cobalt, or the like, having relatively weak magnetic force as compared to neodymium as the material for the magnet, in order to further secure a space on the stator core in which the coil is wound so as to further secure inductance, the thickness of the magnet in the radial direction may be decreased, and a length of the stator core in the radial direction may be increased.

According to the embodiment of the present invention, the thickness B of the magnet 42 in the radial direction corresponds to 8.5 to 20% of the distance A from the center X of rotation of the rotor case 50 to the edge of the rotor case 50 in the outer radial direction, such that even in the case in which at least one of ferrite and samarium cobalt (SmCo) having magnetic force slightly weaker than that of neodymium is used as a material for the magnet, performance of the spindle motor may be improved as compared with the case in which the neodymium magnet is used.

That is, in the case of using the spindle motor according to the embodiment of the present invention, magnetic flux on a surface of the magnet is sufficiently secured by an increase in thickness of the magnet, and magnetic force is secured therein, such that rotational strength is improved, whereby noise and vibrations generated in the spindle motor may be decreased. In addition, the magnetic force is secured, whereby magnetic performance may be improved.

As set forth above, according to the embodiments of the present invention, the magnet formed of ferrite or samarium cobalt (SmCo) having relatively weak magnetic force as compared to that of neodymium is used, whereby a manufacturing cost of the spindle motor can be decreased.

In addition, the spindle motor in which a deterioration in performance is not generated despite using the magnet formed of ferrite or samarium cobalt (SmCo) can be provided.

Further, even in the case in which an outer diameter of the rotor case is not separately increased, the thickness of the magnet formed of ferrite or samarium cobalt (SmCo) is increased in the radial direction, whereby magnetic force can be sufficiently secured.

While the present invention has been shown and described in connection with the embodiments, it will be apparent to those skilled in the art that modifications and variations can be made without departing from the spirit and scope of the invention as defined by the appended claims.

What is claimed is:

1. A rotor assembly for a motor, comprising:
a rotor case including a rotor hub fixed to a shaft, a rotor extension part extended from the rotor hub in an outer radial direction, and a magnet coupling part extended from the rotor extension part in a downward axial direction; and
a magnet provided on an inner surface of the magnet coupling part,
wherein a thickness of the magnet in a radial direction corresponds to 8.5 to 20% of a distance from a center of rotation of the rotor case to an edge of the rotor case in the outer radial direction.

2. The rotor assembly of claim 1, wherein the magnet is formed of at least one of ferrite and samarium cobalt (SmCo).

3. The rotor assembly of claim 1, wherein the magnet is provided in an annular ring shape on the inner surface of the magnetic coupling part.

4. A spindle motor comprising:
a sleeve supporting a shaft such that an upper end of the shaft protrudes in an upward axial direction;
a rotor assembly for a motor, including a rotor case including a rotor hub fixed to a shaft, a rotor extension part extended from the rotor hub in an outer radial direction, and a magnet coupling part extended from the rotor extension part in a downward axial direction, and a magnet provided on an inner surface of the magnet coupling part, a thickness of the magnet in a radial direction corresponding to 8.5 to 20% of a distance from a center of rotation of the rotor case to an edge of the rotor case in the outer radial direction; and
a stator directly or indirectly coupled to an outer peripheral surface of the sleeve and having a coil wound therearound so as to generate rotational driving force.

5. The spindle motor of claim 4, wherein the magnet is formed of at least one of ferrite and samarium cobalt (SmCo).
